(19) United States
(12) Patent Application Publication
(10) Pub. No.: US 2008/0170927 A1
(43) Pub. Date: Jul. 17, 2008

(54) SNAP TOGETHER PUSH BUTTON LATCH MECHANISM

(75) Inventor: Michael A. Boraas, Elgin, MN (US)

Correspondence Address: CANTOR COLBURN LLP - IBM ROCHESTER DIVISION, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/537,770

(22) Filed: Oct. 2, 2006

(51) Int. Cl. F16B 13/06

(52) U.S. Cl. 411/48

(57) ABSTRACT

Disclosed is a push button latch mechanism including a catch, a spring, and a plunger. The catch includes two legs connected to a catch face. Each leg includes a first hook insertable through and retained in a hole in the structure, a second hook extending inward and toward the catch face from the free end, and a third hook insertable into and retained in a hole formed in the cover. The plunger includes a shaft having one or more tabs insertable into a hole in the catch face and retained by it, and a v-notch at the free end of the shaft configured to be accepted into the second hooks of the catch when the plunger is pushed, thereby forcing the legs of the catch closer together and releasing the first hooks from the hole in the structure allowing the cover to be removed. The spring is disposed around the shaft and configured such that when the plunger is released, the plunger returns to its original position.

### BACKGROUND OF THE INVENTION

1. Field of the Invention

This invention relates to electronics devices such as computers and the like. In particular, this invention relates to a push-button latch mechanism for securing a cover to the device.

2. Description of Background

Electronic devices such as computers, printers, and the like typically have covers that must be frequently removed and reinstalled. In many cases, the cover is attached to the electronic device using thumbscrews or the like which must unscrewed each time the cover is removed from the device. This process can be time consuming and may require additional hand tools to accomplish the removal of the cover from the device.

The attachment of the cover to the device is often alternatively accomplished by quick-releasing latch mechanisms. Often these mechanisms are complex, requiring additional features to be added to the cover and the device in secondary manufacturing operations, which increases manufacturing time. The incorporation of these features also often increases the complexity of the tooling used to mold the cover, which in turn can have a negative effect on product cost and quality.

What is needed is a simplified latch mechanism that does not require additional complex features incorporated into the device or cover, and allows the cover to be installed and removed quickly and without additional tools.

### SUMMARY OF THE INVENTION

The shortcomings of the prior art are overcome and additional advantages are provided through the provision of an improved push button latch mechanism comprising a catch, a spring, and a plunger. The catch comprises a catch base with two elastically deformable legs connected to a catch face at one end and extending substantially parallel to one another from the catch face. Each leg includes a first hook extending outward and toward the catch face from the free end and configured to be insertable through and retained in a hole in the structure, a second hook extending inward and toward the catch face from the free end, and a third hook extending outward and toward the catch face at a distance form the free end and disposed and configured to be insertable into and retained in a hole formed in the cover.

The plunger comprises a shaft extending from a plunger face, the shaft insertable into a hole in the catch face and including one or more tabs extending outward and toward the plunger face and disposed and configured to be insertable into the hole in the catch face and retained by it. The shaft also includes a v-notch at the free end of the shaft disposed and configured to be accepted into the second hooks of the catch when the plunger is pushed, so as to force the legs of the catch closer together and release the first hooks from the hole in the structure allowing the cover to be removed. The spring is disposed around the shaft configured such that when the plunger is released, the plunger returns to its original position.

### TECHNICAL EFFECTS

As a result of the summarized invention, technically we have achieved an improved push button latch mechanism that is allows removal and installation of a cover for a device quickly and without the need for hand tools. Adoption of the latch mechanism does not require complex modifications to be made to the cover or to the device.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a perspective exploded view illustrating an exemplary embodiment of a latch mechanism.

FIG. 2 is an enlarged view of the circled area “A” in FIG. 1.

FIG. 3 is an exploded side view of the latch mechanism in FIG. 1.

FIG. 4 is an enlarged view of circled area “B” in FIG. 3.

FIG. 5 is a top view of the cover portion of the latch mechanism in FIG. 1.

FIG. 6 is a side view of the installed latch mechanism in FIG. 1.

The detailed description explains the preferred embodiments of the invention, together with advantages and features, by way of example with reference to the drawings.

### DETAILED DESCRIPTION OF THE INVENTION

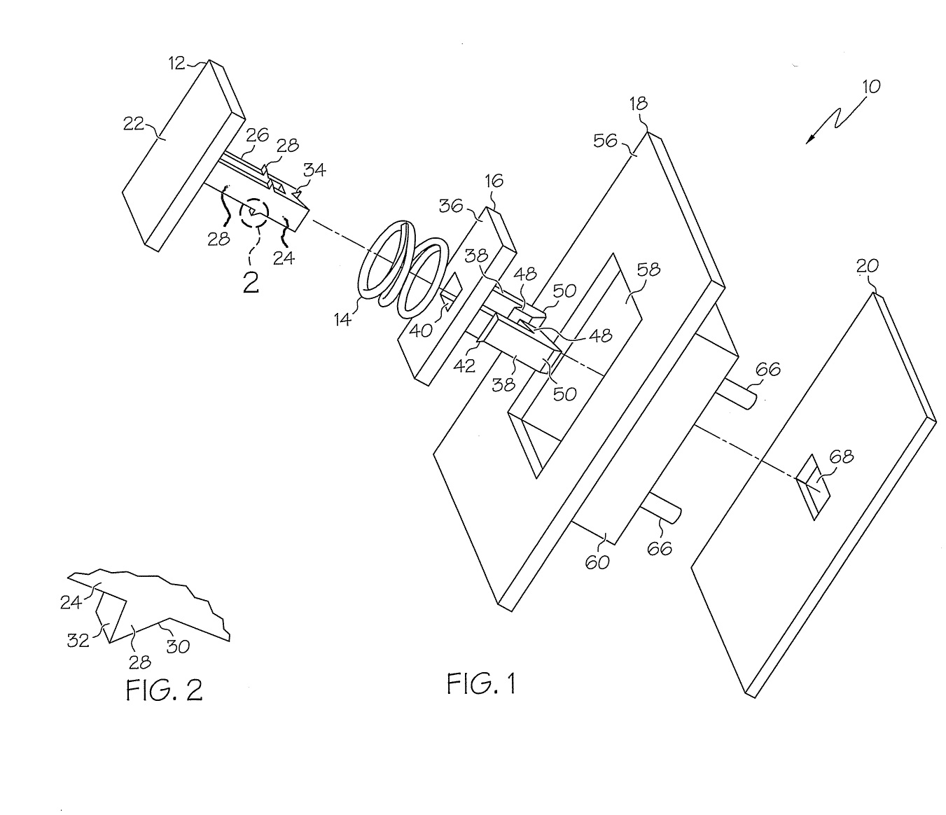

Turning now to the drawings in greater detail, it will be seen that in FIG. 1 there is an embodiment of an improved latch mechanism 10. The latch mechanism 10 comprises a plunger 12, a spring 14, and a catch 16, which secures a cover 18 to a device 20. It should be noted that any number of latch mechanisms 10 may be used to secure the cover 18 to the device 20. In the figures, the cover 18 and the device 20 are shown as partial views for clarity, isolating one securing point.

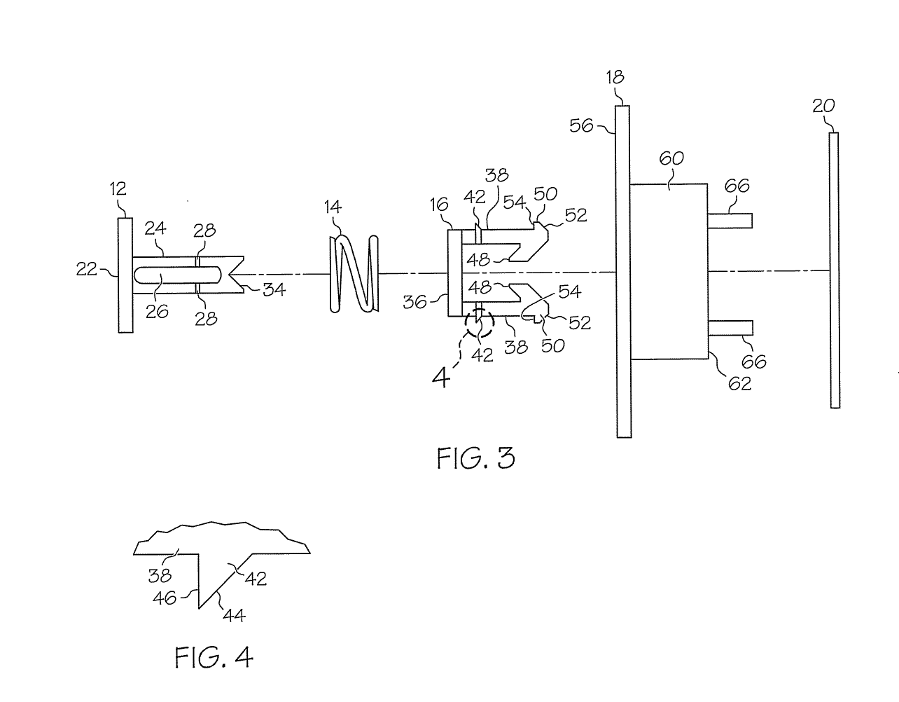

The plunger 12 may be formed from a plastic material and includes a plunger face 22, which in this embodiment has a rectangular shape. A plunger shaft 24 extends substantially from a center of the plunger face 22 and has a cross-section that is generally rectangular. The plunger shaft 24 may include a plunger cavity 26 that eliminates unnecessary material without negatively affecting the strength of the plunger shaft 24. The plunger shaft 24 includes plunger barbs 28 disposed on opposite sides of the plunger shaft 24. As illustrated in FIG. 2, a first plunger barb face 30, furthest from the plunger face 22, slopes toward the plunger face 22, and a second plunger barb face 32, closest to the plunger face 22, is substantially parallel to the plunger face 22. An end of the plunger shaft 24 farthest from the plunger face 22 incorporates a plunger notch 34, which has a V-shape as shown in FIGS. 1 and 3.

Returning now to FIG. 1, the latch mechanism 10 also comprises a catch 16 that may be formed from a plastic material and includes a catch face 36 and two catch legs 38. The catch face 36 is rectangular in shape. A catch hole 40 is a through-hole disposed substantially in the center of the catch face 36. The catch hole 40 is rectangular in shape, and is large enough for the plunger shaft 24 to enter the catch hole 40. The catch hole 40 must be small enough, however, that once the plunger barbs 28 pass through the catch hole 40, that an edge of the catch hole 40 interferes with the second plunger barb face 32 so the plunger 12 cannot be removed from the catch 16.

Turning now to FIG. 3, the two catch legs 38 extend from the catch face 36 in a direction towards the cover 18 and substantially perpendicular to the catch face 36. Each catch leg 38 includes a catch barb 42. As shown in detail in FIG. 4, a first catch barb face 44, furthest from the catch face 36, slopes toward the catch face 36, and a second catch barb face 46, closest to the catch face 36, is substantially parallel to the catch face 36. At an end of each catch leg 38 farthest from the catch face 36, each catch leg 38 includes a catch inner hook 48 and a catch outer hook 50. Each catch inner hook 48 extends from the catch leg 38 into a space between the catch legs 38, and toward the catch face 36 at an angle substantially equal to an angle of the plunger notch 34. The catch outer hooks 50 extend outward from each catch leg 38. A first catch outer hook face 52, furthest from the catch face 36, slopes toward the catch face 36, and a second catch outer hook face 54, closest to the catch face 36, is substantially parallel to the catch face 36.

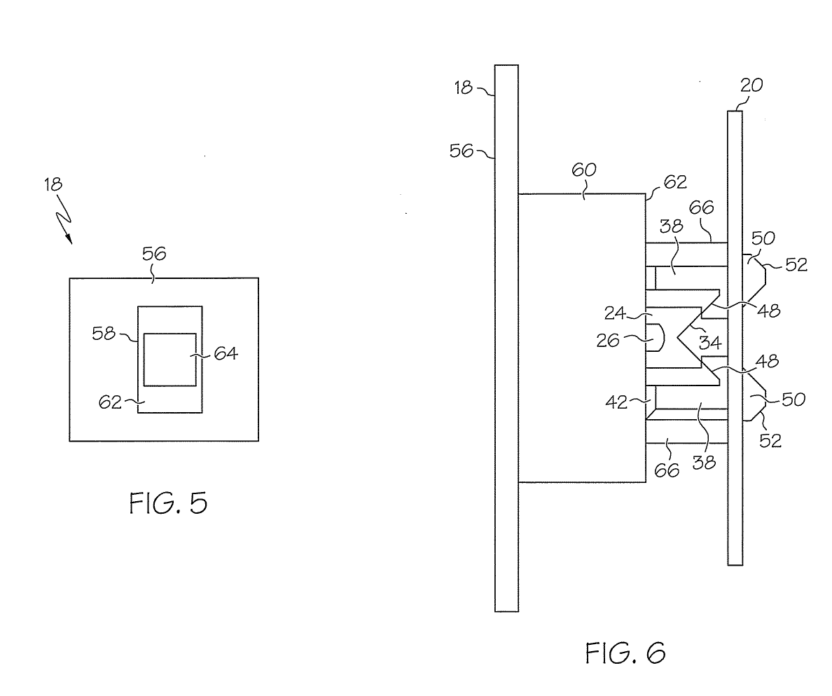

Returning to FIG. 1, use of the latch mechanism 10 is facilitated through features that are molded into the cover 18. A cover face 56 includes a cover hole 58 that is rectangular in shape and is large enough to accommodate the plunger face 22 and the catch face 36. The cover 18 also includes a cover pocket 60 extending from the cover face 56 toward the device 20, and has a pocket face 62 that is substantially parallel to the cover face 56. As shown in FIG. 5, the pocket face 62 includes a pocket hole 64 that allows the installed catch 16 to pass through. Referring again to FIG. 3, two or more spacer ribs 66 extend from the pocket face 62 toward the device 20. The presence of the spacer ribs 66 prevents over travel of the latch mechanism 10 when installed to an attachment hole 68.

The attachment hole 68 is rectangular in shape, and is large enough for the catch legs 38 to pass through the attachment hole 68. The attachment hole 68 must be small enough, however, that once the catch outer hooks 50 pass through the attachment hole 68, that an edge of the attachment hole 68 interferes with the second catch outer hook face 54 so the catch 16 cannot be easily removed from the attachment hole 68.

To install the latch mechanism 10 and thereby secure the cover 18 to the device 20, the catch 16 is installed in the cover 18 by passing the catch legs 38 through the pocket hole 64 until the catch barbs 42pass through the pocket hole 64. The second catch barb face 46 interferes with an edge of the pocket hole 64 so the catch 16 cannot be easily removed from the pocket hole 64. The catch 16 is thus secured in the cover 18. The spring 14 is installed over the plunger shaft 24. The plunger shaft 24 is passed through the catch hole 40 until the plunger barb 28 passes through the catch hole 40, thus securing spring 14 and the plunger 12 to the catch 16. The spring 14 and the plunger barbs 28 are configured so the plunger face 22 is substantially flush with the cover face 56 when the latch mechanism 10 is installed. As shown in FIG. 6, with the latch mechanism 10 installed in the cover 18, the cover 18 is attached to the device 20 by inserting the catch legs 38 through the attachment hole 68. The sloping face of the first catch outer hook face 52 allows the catch legs 38 to pass through the attachment hole 68 directly, without the plunger 12 being depressed.

The latch mechanism 10 allows the cover 18 to be installed and removed from the device 20 quickly and frequently and with out the aid of special tools. To remove the cover 18, the plunger 12 is pushed inward, toward the attachment hole 68. Subsequently, the plunger notch 34 advances into the catch inner hooks 48 causing the catch legs 38 to be pulled closer together. When the catch legs 38 are sufficiently close together, the catch outer hooks 50 will no longer interfere with edges of the attachment hole 68, thus allowing the cover 18 to be pulled away from the device 20.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A latch mechanism for attaching a cover to a structure comprising:
a catch having two elastically deformable legs connected to a catch face at one end and extending substantially parallel to one another from the catch face, each leg including:
a first hook extending outward and toward the catch face from a free end and configured to be insertable through and retained in a hole in the structure;
a second hook extending inward and toward the catch face from the free end; and
a third hook extending outward and toward the catch face at a distance from the free end and disposed and configured to be insertable into and retained in a hole formed in the cover;
a plunger member having a shaft extending from a plunger face, the shaft insertable into a hole in the catch face and including;
one or more tabs extending outward and toward the plunger face and disposed and configured to be insertable into the hole in the catch face and retained by the catch face;
a v-notch at the free end of the shaft disposed and configured to be accepted into the second hooks of the catch when the plunger is pushed, so as to force the legs of the catch closer together and release the first hooks from the hole in the structure allowing the cover to be removed; and
a spring disposed around the shaft configured such that when the plunger is released, the plunger returns to its original position.

2. The latch mechanism of claim 1, wherein the spring and the plunger tabs are configured so an outer surface of the plunger face is flush with an outer surface of the cover when the latch mechanism is installed.

3. The latch mechanism of claim 1, wherein the plunger includes a cavity disposed in the plunger shaft.

4. The latch mechanism of claim 1, wherein the catch legs have a substantially rectangular cross section, corresponding to a hole in the structure which has a rectangular cross section.

5. The latch mechanism of claim 1, wherein an outer the plunger face is substantially rectangular in shape and fits into a substantially rectangular hole in the cover.

6. The latch mechanism of claim 1, wherein the catch is formed from a plastic material.

7. The latch mechanism of claim 1, wherein the plunger is formed from a plastic material.

8. A latch mechanism for attaching a cover to an electronic device comprising:
a catch having two elastically deformable legs connected to a catch face at one end and extending substantially parallel to one another from the catch face, each leg including:
a first hook extending outward and toward the catch face from a free end and configured to be insertable through and retained in a hole in the electronic device;
a second hook extending inward and toward the catch face from the free end; and
a third hook extending outward and toward the catch face at a distance from the free end and disposed and configured to be insertable into and retained in a hole formed in the cover;
a plunger member having a shaft extending from a plunger face, the shaft insertable into a hole in the catch face and including:
one or more tabs extending outward and toward the plunger face and disposed and configured to be insertable into the hole in the catch face and retained by the catch face;
a v-notch at the free end of the shaft disposed and configured to be accepted into the second hooks of the catch when the plunger is pushed, so as to force the legs of the catch closer together and release the first hooks from the hole in the structure allowing the cover to be removed; and
a spring disposed around the shaft configured such that when the plunger is released, the plunger returns to its original position.

9. The latch mechanism of claim 1, wherein the spring and the plunger tabs are configured so an outer surface of the plunger face is flush with an outer surface of the cover when the latch mechanism is installed.

10. The latch mechanism of claim 1, wherein the plunger includes a cavity disposed in the plunger shaft.

11. The latch mechanism of claim 1, wherein the catch legs have a substantially rectangular cross section, corresponding to a hole in the structure which has a rectangular cross section.

12. The latch mechanism of claim 1, wherein an outer the plunger face is substantially rectangular in shape and fits into a substantially rectangular hole in the cover.

13. The latch mechanism of claim 1, wherein the catch is formed from a plastic material.

14. The latch mechanism of claim 1, wherein the plunger is formed from a plastic material.
